(19) United States
(12) Patent Application Publication
(10) Pub. No.: US 2002/0021933 A1
(43) Pub. Date: Feb. 21, 2002

(54) Applicator

(76) Inventor: Paul Knieriemen, New York, NY (US)

Correspondence Address: Warner-Lambert Company, 201 Tabor Rd., Morris Plains, NJ, 07950, US

(21) Appl. No.: 09/915,970

(22) Filed: Jul. 26, 2001

Related U.S. Application Data
(60) Provisional application No. 60/221,641, filed on Jul. 28, 2000.

(51) Int. Cl. B43M 11/06; B43K 5/00

(52) U.S. Cl. 401/202; 401/183

(57) ABSTRACT

An applicator comprises a flexible container having an upper end portion with a dispensing orifice therein. A dimpled applicator head of foam material is secured to an outside surface of the upper end portion. Substances within the flexible container flow through the foam material of the dimpled applicator head to the exterior surface thereof when such substances are dispensed through the orifice. The applicator also has a removable closure cap, and releasable locking structure is provided on an inside surface of the closure cap and an outside surface of the upper end portion of the flexible container so that the closure cap is releasably secured to the flexible container.

This application claims the benefit of Provisional Application No. 60/221,641 filed on Jul. 28, 2000, the entirety of which is hereby incorporated by reference as if fully set forth herein.

### BACKGROUND of the INVENTION

The present invention relates to an applicator comprising a container and a closure cap, and more particularly to an applicator that dispenses and applies the substances within the container where desired.

Many consumer products are packaged in small hand held containers with removable closure caps to retain the freshness of the product between uses thereof. However, these container and closure cap assemblies are somewhat complicated in construction and in many instances they simply function to dispense the material within the container.

### SUMMARY of the INVENTION

Accordingly, it is an object of the present invention to provide an applicator which is simple in construction and simple to use.

Another object of the present invention is an applicator which functions to both dispense and apply the container contents where desired.

In accordance with the present invention, an applicator comprises a flexible container having an upper end portion with at least one dispensing orifice therein. A dimpled applicator head of foam material is secured to the outside surface of the upper end portion of the flexible container whereby substances within the container flow through the foam material of the dimpled applicator head when dispensed through the orifice. A closure cap is removably snap fitted over the upper end portion of the container. Releasable locking structure is located on the inside surface of the closure cap and the outside surface of the upper end portion of the flexible container so that the closure cap is releasably secured to the flexible container.

The releasable locking structure preferably includes a plurality of spaced apart outwardly directed lugs on the upper end portion of the flexible container and a plurality of inwardly directed lugs on the inside surface of the closure cap that snap fit with the lugs on the flexible container. The closure cap preferably includes an oval shaped side wall. The upper end portion of the flexible container has a complimentary oval shape.

In a preferred embodiment of the present invention, the dimpled applicator head of foam material includes a plurality of raised dimples equally spaced apart and arranged along an oval path near the outer edge of the applicator head with several additional dimples positioned within the oval path.

### BRIEF DESCRIPTION of the DRAWINGS

Novel features and advantages of the present invention in addition to those noted above will become apparent to persons of ordinary skill in the art from a reading of the following detailed description in conjunction with the accompanying drawings wherein similar reference characters refer to similar parts and in which:

FIG. 1 is front elevational view of an applicator , according to the present invention, the rear elevational view being identical;

FIG. 2 is a right side elevational view of the applicator shown in FIG. 1, the left side elevational view being identical;

FIG. 3 is a top plan view of the applicator shown in FIGS. 1 and 2, FIG. 4 is a bottom plan view of the applicator shown in FIGS. 1-3;

FIG. 5 is a front elevational view of the applicator shown in FIGS. 1-4 with the closure cap removed, the rear elevational view being identical;

FIG. 6 is a top plan view of the applicator with the closure cap removed;

FIG. 7 is a right side elevational view of the applicator with the closure cap removed, the left side elevational view being identical;

FIG. 8 is a bottom plan view of the closure cap shown in FIGS. 1-4;

FIG. 9 is a partial front elevational view similar to FIG. 1 but with portions broken away to show interior details; and

FIG. 10 is a fragmental enlarged cross-sectional view showing details of the foam head of the applicator.

### DETAILED DESCRIPTION of the INVENTION

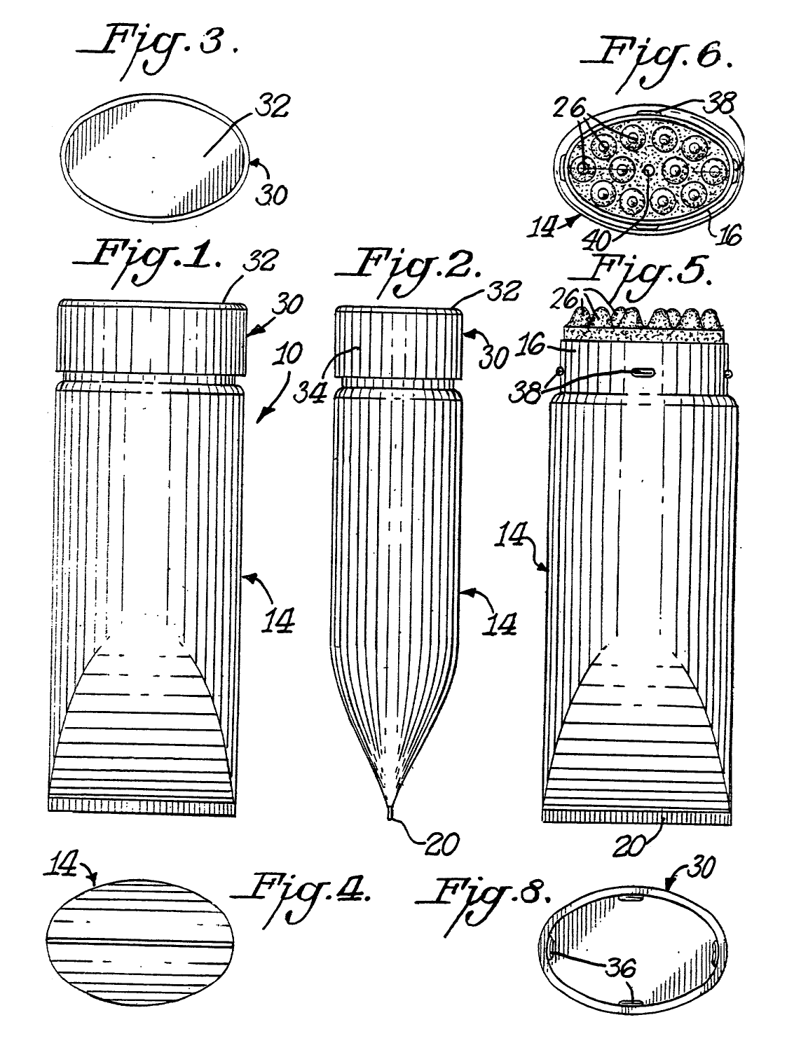

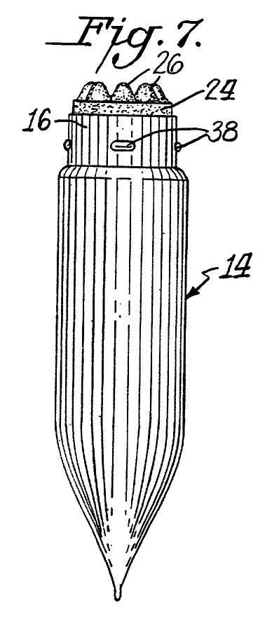

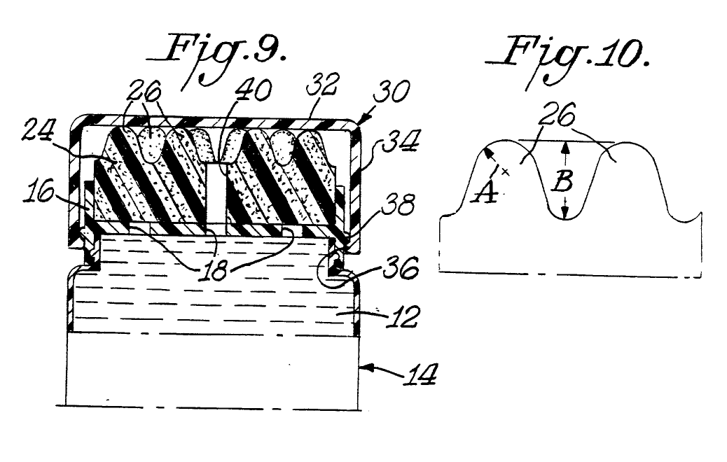

Referring in more particularity to the drawings, FIGS. 1-8 illustrate the exterior features of an applicator 10 for dispensing and applying materials or substances 12, such as ointments, creams and the like. Applicator 10 may be manufactured from any suitable thermoplastic material compatible with the substance packaged. Such thermoplastic materials include polyethylene and polypropylene, for example. Extrusion and welding techniques, well known in the art, may be used to produce the finished applicator product.

Applicator 10 comprises a flexible container 14 having an upper end portion 16. As shown best in FIG. 9, dispensing orifice 18 is provided in the upper end portion 16 of the container. Alternatively, the dispensing orifice may be offset and/or more than one orifice may be used. The lower end of container 14 is closed by a straight seal 20.

The upper end portion 16 of applicator 10 includes an upwardly extending side wall 22, and a dimpled applicator head 24 of foam material is secured within the upwardly extending side wall 22, as shown best in FIG. 9. The foam material consists of closed cell foam, and the substance 12 flows through a passageway 40 in the foam to the exterior surface of the applicator head when the flexible container 14 is squeezed thereby dispensing the substance through the orifice 18 into the foam material. Alternatively, the material of the applicator head may be selected so that the applicator head is impregnated with substance 12 when the container is squeezed.

The upper surface of the applicator head includes a plurality of spaced apart bumps or dimples 26, each having a height B of approximately 1/8to 1/4inches and a circular base dimension having a radius A of 1/8to 1/4inches. As shown best in FIG. 6, the dimples 26 are equally spaced apart and arranged along an oval path near the outer edge of the applicator head with several additional dimples positioned within the oval path. Although twelve dimples are shown, if the dimples are larger, a lesser number may be sufficient. Also, if the dimples are smaller, more dimples may be desirable.

Applicator 10 also includes a flexible closure cap 30 having a generally flat top 32 and a downwardly extending surrounding side wall 34. Closure cap 30 snap fits over the upper end portion 16 of the flexible container to releasably secure the closure cap to the container. Releasable locking structure providing the snap fit is located on the inside of the surrounding wall 34 and on the outside of the upper end portion 16. The locking structure on the inside of a surrounding wall 34 includes four equally spaced apart inwardly extending lugs 36, and the locking structure on the outside surface of the upper end portion 16 includes four equally spaced apart outwardly extending lugs 38 in vertical alignment with the lugs 36 on the closure cap.

In the preferred embodiment of the present invention, the surrounding wall 34 of the closure cap has an oval shape and the upper end portion of the flexible container has a complimentary oval shape. Accordingly, whenever the closure cap is fitted over the upper end potion of the flexible container, the lugs 36 and 38 are always in vertical alignment with one another to produce the desired interference with one another which produces the snap fit.

In use, the closure cap is first removed from the upper end portion of the flexible container to expose the applicator head 24 of foam material. Container 14 is then gently squeezed to dispense substance 12 through orifice 18 into the foam material to the exterior surface thereof. The applicator head 24 is then rubbed over the desired area to stimulate that area and simultaneously apply substance 12. Upon completion of the application process, the closure cap is returned and snap fitted over the upper end portion of the container to preserve the freshness of the packaged substance.

What is claimed is:

1. An applicator comprising a flexible container and a closure cap, the flexible container having an upper end portion with at least one dispensing orifice therein, a dimpled applicator head of foam material secured to an outside surface of the upper end portion whereby substances within the flexible container flow through the foam material of the dimpled applicator head when dispensed through the orifice, and releasable locking structure on an inside surface of the closure cap and an outside surface of the upper end portion of the flexible container whereby the closure cap is releasably secured to the flexible container.

2. An applicator as in claim 1 wherein the releasable locking structure includes a plurality of spaced apart outwardly directed lugs on the upper end portion of the flexible container and a plurality of inwardly directed annular lugs on the inside surface of the closure cap that snap fit with the lugs on the flexible container.

3. An applicator as in claim 1 wherein the closure cap includes an oval shaped side wall, and wherein the upper end portion of the flexible container has a complementary oval shape.

4. An applicator as in claim 1 wherein the dimpled applicator head of foam material includes a plurality of raised dimples equally spaced apart and arranged along an oval path near an outer edge of the applicator head with several additional dimples positioned within the oval path.
